(19) United States
(12) Patent Application Publication
(10) Pub. No.: US 2019/0128050 A1
(43) Pub. Date: May 2, 2019

(54) Improved Sectional Door

(71) Applicant: Steven Ronald Canning and Claudia Marina Canning ATF The Steven Ronald Canning Family Trust, Dianella, Western Australia (AU)

(72) Inventors: Steven Ronald Canning, Dianella, Western Australia (AU); Christopher Neil Canning, Dianella, Western Australia (AU); Peter Francis William, Tuart Hill, Western Australia (AU)

(21) Appl. No.: 16/088,878

(22) PCT Filed: Mar. 29, 2017
(86) PCT No.: PCT/AU2017/050270

§ 371 Date: Sep. 27, 2018

(30) Foreign Application Priority Data
Mar. 30, 2016 (AU) 2016901168

(51) Int. Cl. E06B 3/48; E05D 15/24

(52) U.S. Cl. CPC E06B 3/488; E05Y 2900/132; E05Y 2900/106; E05D 15/242

(57) ABSTRACT

A panel for a sectional door, the panel comprising: (a) a front wall; (b) a rear wall; (c) a top edge; (d) a bottom edge; (e) two side edges; (f) a first mounting means for mounting the panel in a pair of first guide tracks, one of each said pair of first guide tracks located adjacent each of said side edges; (g) a first rigid reinforcement member extending between said top and bottom edges to reinforce said panel against deflection; and (h) a first non-rigid restraining member located between said side edges to restrict the deflection of the panel, wherein said first non-rigid restraining member defines a path that runs adjacent to or through said first rigid reinforcement member and comprises a second mounting means for anchoring said first non-rigid reinforcement member to an anchor point.

### FIELD OF THE INVENTION

The present invention relates to a sectional door panel, a sectional door, such as a garage sectional door and to a system for a sectional door.

### BACKGROUND OF THE INVENTION

Sectional doors are required to meet various engineering requirements including wind loads when in a closed position to ensure the door is able to withstand pressure forces acting on the door both inwardly and outwardly due to ambient winds. Failure of a sectional door in high winds can result in the door becoming loose or completely free from its mounting frame causing damage to people and/or property.

One way of strengthening sectional doors is to manufacture the doors from stronger or thicker material. Another way involves reinforcing the doors with rigid struts, beams or bars.

However, these types of modifications increase manufacturing costs and result in doors that are substantially heavier which can hamper storage, transportation, installation and operation of the doors. For example, the heavier a door the more powerful a motor is required to operate the door.

Accordingly, there is a need to provide an improved sectional door that addresses or at least partially alleviates the problems with existing sectional doors.

### SUMMARY OF THE INVENTION

The present invention provides a panel for a sectional door, the panel comprising:
(a) a front wall;
(b) a rear wall;
(c) a top edge;
(d) a bottom edge;
(e) two side edges;
(f) a first mounting means for mounting the panel in a pair of first guide tracks, one of each said pair of first guide tracks located adjacent each of said side edges;
(g) a first rigid reinforcement member extending between said top and bottom edges to reinforce said panel against deflection; and
(h) a first non-rigid restraining member located between said side edges to restrict the deflection of the panel, wherein said first non-rigid restraining member defines a path that runs adjacent to or through said first rigid reinforcement member and comprises a second mounting means for anchoring said first non-rigid reinforcement member to an anchor point.

The present invention also provides a sectional door comprising a plurality of panels, wherein at least one of said panels comprises a panel according to a first aspect of the present invention.

### BRIEF DESCRIPTION OF THE DRAWINGS

FIG. 1A is a isometric view from the rear of a sectional door according to a first embodiment of the second aspect of the present invention mounted in a pair of first guide tracks and including a plurality of panels according to a first embodiment of the first aspect of the present invention;

FIG. 1B is a detailed view of the top corner of a panel from the sectional door in FIG. 1A;

FIG. 1C is a detailed view of a part of the sectional door in FIG. 1A showing the intersection between two adjacent panels;

FIG. 2A is a isometric view from the rear of a sectional door according to a second embodiment of the second aspect of the present invention mounted in a pair of first guide tracks and including a plurality of panels according to a second embodiment of the first aspect of the present invention; and

FIG. 2B is a detailed view of a part of the sectional door in FIG. 2A showing the intersection between two adjacent panels.

### DETAILED DESCRIPTION OF THE INVENTION

According to a first aspect of the present invention there is provided a panel for a sectional door, the panel comprising:
(a) a front wall;
(b) a rear wall;
(c) a top edge;
(d) a bottom edge;
(e) two side edges;
(f) a first mounting means for mounting the panel in a pair of first guide tracks, one of each said pair of first guide tracks located adjacent each of said side edges;
(g) a first rigid reinforcement member extending between said top and bottom edges to reinforce said panel against deflection; and
(h) a first non-rigid restraining member located between said side edges to restrict the deflection of the panel, wherein said first non-rigid restraining member defines a path that runs adjacent to or through said first rigid reinforcement member and comprises a second mounting means for anchoring said first non-rigid reinforcement member to an anchor point.

The path defined by the first non-rigid restraining member may run at between 80° and 100° to said first rigid reinforcement member. Preferably, said path runs perpendicular or between 85° and 95° to the first rigid reinforcement member. In one particular form of the invention the path runs at about 90° to the first rigid reinforcement member.

When the path defined by the first non-rigid restraining member runs adjacent to the first rigid reinforcement member it may run in front of the first rigid reinforcement member or to the rear of the first rigid reinforcement member.

When said path runs in front of the first rigid reinforcement member it may run between the first rigid reinforcement member and the rear wall of the panel. In this regard, it is preferred that a space large enough to accommodate the at least one non-rigid restraining member is defined between the front of the first rigid reinforcement member and the rear wall of the panel.

Preferably, the path extends the majority of the length of the panel and even more preferably the path extends the entire length of the panel. Preferably, said path terminates adjacent at or near the two side edges of the panel. Even more preferably, said path terminates at an anchor point adjacent at or near the two side edges of the panel. Preferably, the path extends between at least two anchor points.

When the panel comprises a plurality of first rigid reinforcing members the path may pass to the front of one first rigid reinforcing member, to the rear of another first reinforcing member and through another first reinforcing member. The path may also run according any combination of at least two of these options or the path may run through the same position relative to each first reinforcing member i.e. it may run the front, rear or through each of a plurality of first reinforcement members.

When said path runs to the rear of the first rigid reinforcement member it may run through a first supporting member located on the rear of the first rigid reinforcement member. Thus, the panel may further comprise a first supporting member located on the rear of the first rigid reinforcement member.

When said path runs through the first rigid reinforcement member, the first rigid reinforcement member may comprise a conduit, passage or aperture therein to allow the passage of the first non-rigid restraining member therethrough.

The first supporting member may comprise a loop member through which the non-rigid restraining member passes. Even more preferably, the first supporting member comprises two loop members. In one form of the invention, the first supporting member is a buckle member. The first supporting member may be removably fixed to the first rigid reinforcement member. Alternatively, the first supporting member may be provided integrally with the first rigid reinforcement member. The panel may comprise a plurality of first supporting members.

Preferably, the first mounting means is adapted to slide or roll within a first guide track when mounted therein. Preferably, the first mounting means is adapted to be mounted in and retained by the first guide track. Preferably, the first mounting means comprises a roller assembly. Even more preferably, the first mounting means comprises a roller and a shaft.

The first mounting means may be attached to the rear of the panel directly or via the first rigid reinforcing member. The first mounting means may further comprise a bracket assembly for facilitating its attachment to the panel.

Preferably, the first non-rigid restraining member is elongate and is sized to extend along the majority of the length of the panel. The first non-rigid restraining member may comprise a belt member or a strap member. Alternatively, the first non-rigid restraining member may comprise a line member such as a cable member, a rope member a cord member or a tube member. Preferably, the first non-rigid restraining member comprises flat webbing or tubular webbing.

The first non-rigid restraining member may be formed of any suitable material such as a textile or other webbing or woven material provided it has the required strength to fulfil its role. The first non-rigid restraining member may be formed of a synthetic fibre such as nylon, polypropylene or polyester.

The elasticity of the first non-rigid restraining member may be varied provided it is suitable for its purpose of restraining the panel and hence the preventing the sectional door from separating from its mounting arrangement. In this regard, by limiting the deflection of the panel, the amount of force required to separate the sectional door from its mounting is increased. Preferably, the first non-rigid restraining member has a Young's Modulus of about 0.5-170 GPa. The first non-rigid restraining member may also have a Young's Modulus of less than 180, 170, 160, 150, 140, 130, 120, 110, 100, 90, 80, 70, 60 or 50 GPa. Preferably, the first non-rigid restraining member has a Young's Modulus of about 1-75, 2-65, 1-10, 2-7, 2 GPa or 45-65, 50-60 or 56 GPa.

The panel may comprise a plurality of first non-rigid restraining members.

For the purposes of the present invention the term “restraining” in the term “first non-rigid restraining member” means to prevent, control or otherwise limit the deflection of a panel. Preferably, the “first non-rigid restraining member” allows for controlled deflection of the panel. Even more preferably, the “first non-rigid restraining member” limits the deflection of a panel to the extent that a sectional door including the panel remains mounted or fitted and is otherwise prevented from breaking free or becoming detached from its installed position or an anchor point.

Preferably, the second mounting means for anchoring the first non-rigid restraining member comprises an attachment point for an anchor point. Preferably, the second mounting means comprises two attachment points for two anchor points. Preferably, the attachment points are located at or towards each end of the first non-rigid restraining member, when in use.

The attachment point can be any means capable of being attached to an anchor point. Preferably, the attachment point comprises a first part adapted to be attached to the anchor point and a second part adapted to be attached to the body of the non-rigid restraining member.

Preferably, the second part of the attachment point comprises at least one loop member through which the body of the non-rigid restraining member passes. In one form of the invention, the second part of the attachment point comprises a buckle member.

The anchor points provide a base for the non-rigid restraining member to perform its role in preventing, controlling or otherwise limiting the deflection of a panel that could occur in high winds. Thus, the anchor points are located to ensure that sufficient tension in the non-rigid restraining member is maintained for it to perform regardless of the deflection of the panel. Thus, preferably, the anchor point is the first mounting means such as the roller assembly. However, the anchor point may be another member or assembly that is mounted in the guide track or in another track that is attached to the structure in which the panel is located.

Preferably, there is at least two anchor points for each non-rigid restraining member.

Preferably, the first rigid reinforcement member comprises a square or rectangular cross-sectional shape. Preferably, the first rigid reinforcement member comprises a metal material.

The panel may comprise a plurality of first rigid reinforcement members. When there is a plurality of first rigid reinforcement members the non-rigid restraining member may define a path that passes in front of one of the first rigid reinforcement members and to the rear of another first rigid reinforcement member and/or through another first rigid reinforcement member.

Preferably, the first rigid reinforcement member is adapted to be connected endwise to another first rigid reinforcement member. Preferably, such a connection is a hinged connection.

Preferably, the panel comprises a plurality of first rigid reinforcement members. Preferably, the panel comprises at least one first rigid reinforcement member located towards each of the two side edges of the panel and one first rigid reinforcement member located therebetween. Even more preferably, there are two first rigid reinforcement members located therebetween.

The panel may further comprise a second rigid reinforcement member extending between said two side edges to reinforce said panel against deflection. The second rigid reinforcement member may be of any shape or design to suit the intended purpose.

A panel according to the first aspect of the invention may form part of a sectional door. Thus, according to a second aspect of the present invention there is provided a sectional door comprising a plurality of panels, wherein at least one of said panels comprises a panel according to a first aspect of the present invention. Preferably, the sectional door further comprises a means for attaching the plurality of panels together. Preferably, adjacent panels of the sectional door are hingedly connected to each other.

Preferably, adjacent panels of the sectional door are connected to each other with a second non-rigid restraining member. Preferably, the second non-rigid restraining member is elongate and is sized to extend between first rigid reinforcement members on adjacent panels to reinforce said sectional door against deflection. In particular, the second non-rigid restraining member is adapted to restrain the joint between adjacent panels against deflection beyond that required to allow efficient operation of the sectional door. Preferably, the said second non-rigid restraining member defines a path that runs between the rear surfaces of two adjacent panels.

The second non-rigid restraining member may comprise a belt member or a strap member. Alternatively, the second non-rigid restraining member may comprise a line member such as a cable member, a rope member a cord member or a tube member. Preferably, the second non-rigid restraining member comprises flat webbing or tubular webbing.

The second non-rigid restraining member may be formed of any suitable material such as a textile or other webbing or woven material provided it has the required strength to fulfil its role. The second non-rigid restraining member may be formed of a synthetic fibre such as nylon, polypropylene or polyester. The second non-rigid restraining member may be formed of the same material as the first non-rigid restraining member alternatively, the second non-rigid restraining member may comprise a strap member and the first non-rigid restraining member may comprise a line member such as a cable member.

The elasticity of the second non-rigid restraining member may be varied provided it is suitable for its purpose of restraining adjacent panels by limiting movement or expansion of the joint therebetween and hence the preventing the adjacent panels from separating and/or the sectional door from separating from its mounting arrangement. Preferably, the second non-rigid restraining member has a Young's Modulus equivalent to that of the first non-rigid restraining member.

The sectional door may comprise a plurality of second non-rigid restraining members.

The second non-rigid restraining members may be attached directly to the rear of the panel or first rigid member e.g. stile or indirectly via a bracket or some other mount that is attached to the panel or stile.

Preferably, the adjacent to or through said first rigid reinforcement member and comprises a second mounting means for anchoring said first non-rigid reinforcement member to an anchor point.

For the purposes of the present invention the term “restraining” in the term “second non-rigid restraining member” means to prevent, control or otherwise limit the deflection of a sectional door at a joint, such as a hinged joint, between adjacent panels. Preferably, the “second non-rigid restraining member” allows for controlled deflection of said joint or restrains or prevents the joint from expanding or the adjacent panels separating. Even more preferably, the “second non-rigid restraining member” limits the deflection of the joint to the extent that the sectional door is otherwise prevented from breaking free or becoming detached from its installed position or an anchor point.

### General

Those skilled in the art will appreciate that the invention described herein is susceptible to variations and modifications other than those specifically described. The invention includes all such variation and modifications. The invention also includes all of the steps and features referred to or indicated in the specification, individually or collectively and any and all combinations or any two or more of the steps or features.

Each document, reference, patent application or patent cited in this text is expressly incorporated herein in their entirety by reference, which means that it should be read and considered by the reader as part of this text. That the document, reference, patent application or patent cited in this text is not repeated in this text is merely for reasons of conciseness. None of the cited material or the information contained in that material should, however be understood to be common general knowledge.

The present invention is not to be limited in scope by any of the specific embodiments described herein. These embodiments are intended for the purpose of exemplification only. Functionally equivalent products and methods are clearly within the scope of the invention as described herein.

The invention described herein may include one or more range of values (e.g. size etc.). A range of values will be understood to include all values within the range, including the values defining the range, and values adjacent to the range which lead to the same or substantially the same outcome as the values immediately adjacent to that value which defines the boundary to the range.

For the purposes of the present invention the terms “front” and “rear” refer to facing directions relative to the installed position of a door i.e. the rear part of a component such as a door panel is the part of the door panel that faces towards the space inside the opening closed by the door and the front part of a door panel is the part of the door panel that faces towards the space outside the opening.

It will also be appreciated that the panels and sectional doors of the subject invention may comprise additional rigid reinforcement members beyond those specifically defined by the invention. For example, a panel comprising a first rigid reinforcement member may further comprise additional rigid reinforcement members or struts that span part of the entire length or width of the panel. To the extent that these are included it is expected that their mass and size will be reduced relative to panels that are not manufactured according to the present invention.

Throughout this specification, unless the context requires otherwise, the word “comprise” or variations such as “comprises” or “comprising”, will be understood to imply the inclusion of a stated integer or group of integers but not the exclusion of any other integer or group of integers.

Other definitions for selected terms used herein may be found within the detailed description of the invention and apply throughout. Unless otherwise defined, all technical terms used herein have the same meaning as commonly understood to one of ordinary skill in the art to which the invention belongs.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

### DESCRIPTION OF THE PREFERRED EMBODIMENTS

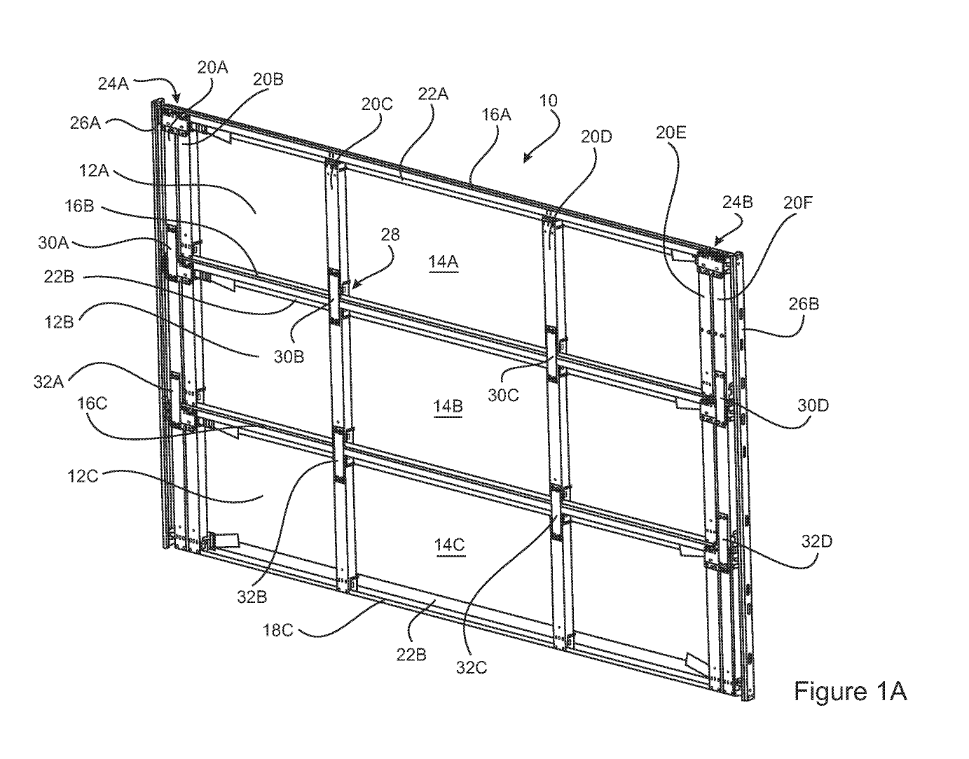

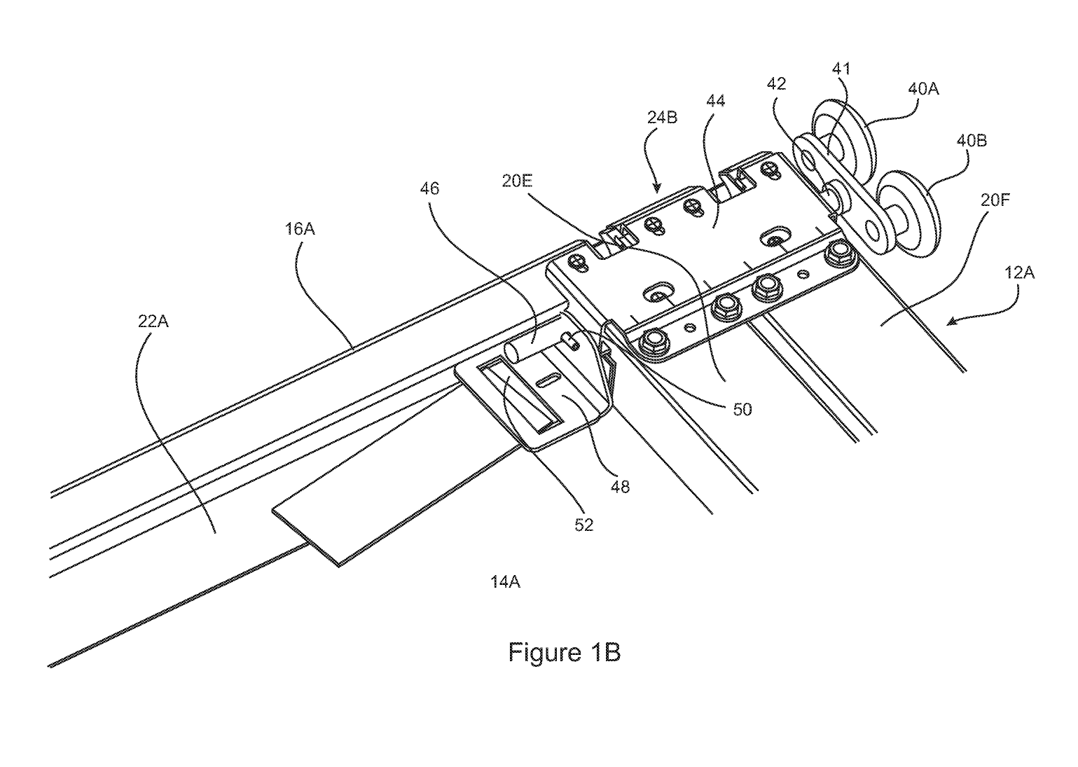

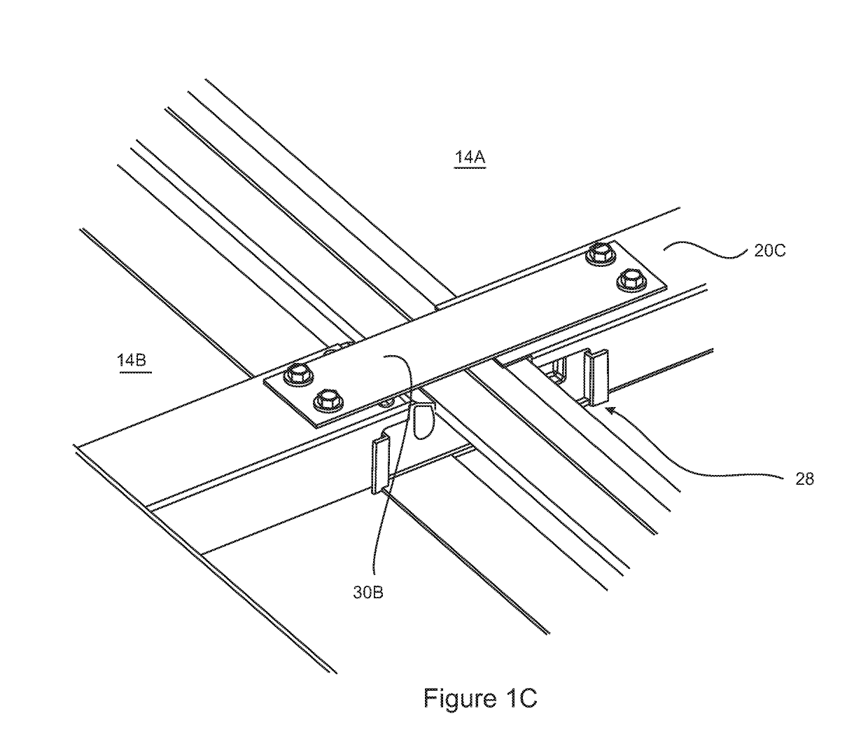

The sectional door, generally indicated by the numeral 10 in FIG. 1A comprises a top panel 12A, middle panel 12B and bottom panel 12C. Each of panels 12A-12C include a front wall (not visible), a rear wall 14A, 14B, 14C, a top edge 16A, 16B and 16C, a bottom edge 18C and two side edges (not visible).

Top panel 12A includes six first rigid reinforcement members in the form of vertical mullions, muntins or stiles 20A-20F. A pair of stiles 20A, 20B and 20E, 20F is located at each end and two further stiles 20C, 20D are positioned intermediately on the rear 14A of top panel 12A. Top panel 12A also includes a first non-rigid restraining member in the form of a strap 22A that defines a path that runs horizontally, adjacent to and in front of stiles 20C, 20D and is anchored at each upper corner of the panel 12A via a first mounting means in the form of roller assemblies 24A, 24B that attach the panel 12A to the guide tracks 26A, 26B located adjacent to the side of the panel 12A. It will be noted that the guide tracks 26A, 26B are only part of a longer guide track assembly (not shown) that allows for the door 10 to be lifted and stowed to allow access to the space at the rear of the door 10. The roller assemblies 24A, 24B and the strap 22A are best shown in FIG. 1B that details the connection between strap 22A and roller assembly 24B. This is described in more detail later herein.

Top panel 12A is connected to the middle panel 12B via a hinged connection that includes a hinged connection 28 between each of stiles 20A-20F on the top panel 12A and the adjacent stiles on the middle panel 12B. The middle panel 12B is similarly connected to the bottom panel 12C.

Top panel 12A is connected to the middle panel 12B via a second non-rigid restraining member in the form of a series of straps 30A-30D that are mounted on stiles 20A, 20C, 20D and 20F of the top panel 12A and the adjacent stiles on the middle panel 12B.

Straps 30A-30D act to restrain the deflection of the joints between the top panel 12A and middle panel 12B. A similar arrangement of straps 32A-32D is mounted between middle panel 12B and bottom panel 12C. The detail of this section of the sectional door is best depicted in FIG. 1C and shows the strap 30B being attached directly to the stile 20C. However, the strap 30B may also be attached to the stile 30B via an intermediate member such as a bracket or buckle member that is attached to the stile 30B.

Middle panel 12B and bottom panel 12C have a similar construction to top panel 12A and therefore are not described separately in detail herein. However, bottom panel 12C includes an additional strap 22B.

FIG. 1B is a more detailed view of the part of top panel 12A that includes the first mounting means in the form of roller assembly 24B that includes twin rollers 40A, 40B mounted on common rail 41 that is in turn mounted on a first end of shaft 42. In use, rollers 40A, 40B are located in guide track (not shown). Shaft 42 is attached to the panel via bracket 44 and the second end 46 of shaft 42 is attached to the strap 22A via a second mounting means in the form of buckle member 48 that includes a first part in the form of an aperture through which the second end 46 of shaft 42 passes and is retained thereon by locking pin 50. The second part of buckle member 48 comprises a loop member 52 through which the strap 22A passes and is retained therein. Hence strap 22A is anchored via its buckle member 48 to an anchor point in the form of the roller assembly 24B that is attached to the panel and to the guide track 26B. A similar mounting and anchoring arrangement exists at the opposite end of the top panel 12A. Note that buckle member 48 could also be attached to bracket 44 by being bolted thereto.

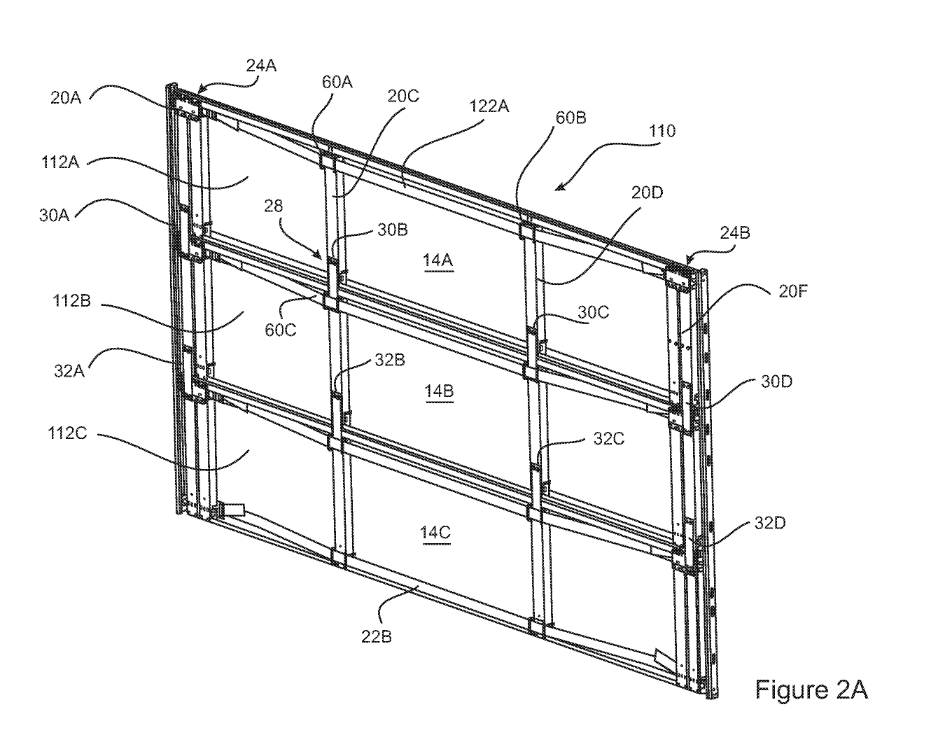

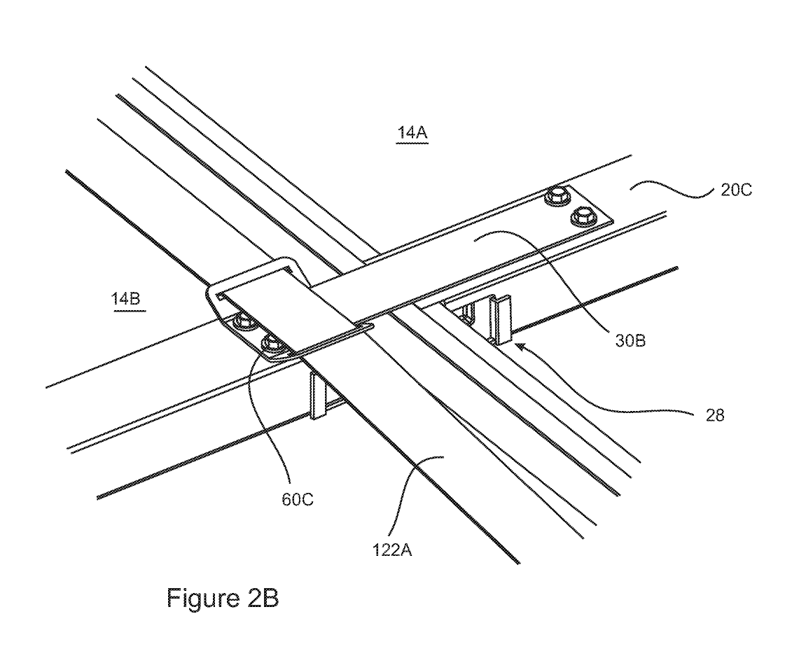

The sectional door, generally indicated by the numeral 110 in FIG. 2A also comprises a top panel 112A, middle panel 112B and bottom panel 112C and is similar in many ways to the sectional door in FIG. 1A. Unless stated to the contrary herein, features in FIGS. 2A-2B that correspond to features in FIGS. 1A-1C function in the same manner. However, whilst the strap 122A located towards the uppermost part of panels 112A-112C is anchored to the roller assemblies 24A, 24B in the same manner as the strap 22A in FIG. 1A, it defines a path that runs horizontally, adjacent to and to the rear of stiles 20C, 20D and passes through first supporting members in the form of loop members 60A, 60B mounted on the rear of the stiles 20C, 20D and through which the strap 22A passes.

The panel 112A-112C are hingedly connected to their neighbouring panel and top panel 112A is connected to the middle panel 112B via a series of straps 30A-30D that are mounted on stiles 20A, 20C, 20D and 20F of the top panel 112A and the adjacent stiles on the middle panel 112B. A similar arrangement of straps 32A-32D is mounted between middle panel 112B and bottom panel 112C. The detail of this section of the sectional door is best depicted in FIG. 2B. It is noted that the straps 30A-30D and 32A-32D share a mounting point with the respective loop members such as 60C.

Middle panel 112B and bottom panel 112C have a similar construction to top panel 12A and therefore are not described separately in detail herein. However, bottom panel 112C includes an additional strap 22B.

1-35. (canceled)

36. A panel for a sectional door, the panel comprising:
(a) a front wall;
(b) a rear wall;
(c) a top edge;
(d) a bottom edge;
(e) two side edges;
(f) a first mounting means for mounting the panel in a pair of first guide tracks, one of each said pair of first guide tracks located adjacent each of said side edges;
(g) a first rigid reinforcement member extending between said top and bottom edges to reinforce said panel against deflection; and
(h) a first non-rigid restraining member located between said side edges to restrict the deflection of the panel, wherein said first non-rigid restraining member defines a path that runs adjacent to or through said first rigid reinforcement member and comprises a second mounting means for anchoring said first non-rigid reinforcement member to an anchor point.

37. The panel according to claim 36, wherein the path defined by the first non-rigid restraining member runs adjacent to and in front of the first rigid reinforcement member.

38. The panel according to claim 36, wherein the path defined by the first non-rigid restraining member runs adjacent to and to the rear of the first rigid reinforcement member.

39. The panel according to claim 36, wherein the path defined by the first non-rigid restraining member runs through the first rigid reinforcement member.

40. The panel according to claim 36 comprising a plurality of first rigid reinforcement members and, wherein the path defined by the first non-rigid restraining member runs adjacent to and to the rear of one first rigid reinforcement member and to the front of another rigid reinforcement member.

41. The panel according to claim 36 comprising a plurality of first rigid reinforcement members and, wherein the path defined by the first non-rigid restraining member runs adjacent to and to the rear of one first rigid reinforcement member and through another rigid reinforcement member.

42. The panel according to claim 36 comprising a plurality of first rigid reinforcement members and, wherein the path defined by the first non-rigid restraining member runs adjacent to and to the front of one first rigid reinforcement member and through another rigid reinforcement member.

43. The panel according to claim 36, further comprising a first supporting member through which the non-rigid restraining member passes.

44. The panel according to claim 43, wherein the first supporting member comprises a buckle member.

45. The panel according to claim 36, wherein the first non-rigid restraining member comprises a strap member.

46. The panel according to claim 45, wherein the strap member comprises flat webbing.

47. The panel according to claim 36, wherein the first non-rigid restraining member comprises a cable member.

48. The panel according to claim 36, further comprising a plurality of first non-rigid restraining members.

49. The panel according to claim 36, wherein the first mounting means comprises a roller assembly.

50. The panel according to claim 36, wherein the non-rigid restraining member is anchored at each of its ends at or near the two side edges of the panel via a second mounting means.

51. The panel according to claim 50, wherein the second mounting means comprises an attachment point for an anchor point.

52. The panel according to claim 51, wherein the attachment point comprises a first part adapted to be attached to the anchor point and a second part adapted to be attached to the body of the non-rigid restraining member.

53. The panel according to claim 36, wherein the anchor point is a roller assembly.

54. The panel according to claim 36, wherein the anchor point is adapted to be mounted in the guide track for the panel.

55. The panel according to claim 36, further comprising a second rigid reinforcement member extending between said two side edges to reinforce said panel against deflection.
